(19) United States
(12) Patent Application Publication
(10) Pub. No.: US 2016/0009069 A1
(43) Pub. Date: Jan. 14, 2016

(54) RAPID PRINTING APPARATUS AND METHOD

(71) Applicant: MICROJET TECHNOLOGY CO., LTD., Hsinchu (TW)

(72) Inventors: Hao-Jan Mou, Hsinchu (TW); Kwo-Yuan Shi, Hsinchu (TW); Chin-Tsung Chen, Hsinchu (TW); Chi-Feng Huang, Hsinchu (TW)

(21) Appl. No.: 14/793,899

(22) Filed: Jul. 8, 2015

(30) Foreign Application Priority Data
Jul. 10, 2014 (TW) 103123788

(51) Int. Cl. B32B 38/00; B32B 38/10; B32B 37/18

(52) U.S. Cl. CPC B32B 38/145; B32B 37/18; B32B 38/0004; B32B 38/10; B33Y 10/00

(57) ABSTRACT

A rapid printing apparatus is selectively operated in a two-dimensional printing mode or a three-dimensional printing mode. The rapid printing apparatus includes a sheet material supplying mechanism, a printing mechanism and a laminated sheet processing mechanism. The sheet material supplying mechanism is used for supplying a sheet material. The printing mechanism is used for printing on a specified area of the sheet material. In the two-dimensional printing mode, the laminated sheet processing mechanism cuts the printed sheet material to a specified size and collects the printed sheet material. In the three-dimensional printing mode, the laminated sheet processing mechanism cuts the printed sheet material to plural sheet segments with the specified size and laminates the plural sheet segments into a three-dimensional laminated block.

### FIELD OF THE INVENTION

The present invention relates to a rapid printing apparatus, and more particularly to a rapid printing apparatus that is selectively operated in a two-dimensional printing mode or a three-dimensional printing mode. The present invention relates to a rapid printing method for the rapid printing apparatus.

### BACKGROUND OF THE INVENTION

As kwon, a rapid prototyping (RP) technology is developed from the concepts of forming a pyramid by stacking layers, and the main technical feature is to achieve fast formation. A complicated design can be transformed into a three-dimensional physical model automatically and fast without any cutting tools, molds and fixtures. Thus, the development cycle of new products and research and development cost are largely reduced to ensure the time to market for new products and the first-time-right ratio. Accordingly, a complete and convenient product design tool is provided between technicians and non-technicians (e.g. managers and users), and the product competitiveness and the quick reaction capability of enterprises in the market are improved obviously.

With increasing development of the rapid prototyping technology, the methods for producing the three-dimensional physical model are diversified. For example, the rapid prototyping methods include a three-dimensional printing method (3-DP), a stereo-lithography method (SLA), a selective laser sintering method (SLS), a solider process (SP), a fused deposition modeling method (FDM), a laminated object manufacturing method (LOM), and so on.

In the conventional three-dimensional printing method, a layer of power is firstly spread, and then a liquid binder is ejected to the spread powder. After the liquid binder is dried and the excess powder is removed, a construction layer is formed. Then, another layer of power is spread to the construction layer, and the liquid binder is ejected to the spread powder. After the liquid binder is dried and the excess powder is removed, another construction layer is formed. The above steps are repeatedly done. Consequently, a three-dimensional physical model is produced by stacking multiple layers. However, the powder spreading step, the printing step, the binder solidifying step and the excess powder removing step of the conventional three-dimensional printing method are time-consuming. After one construction layer is formed, the above steps should be repeatedly performed. Generally, the conventional three-dimensional printing method takes about 10 hours (or more) to produce a three-dimensional object. That is, the conventional three-dimensional printing method is time-consuming and complicated.

In the conventional laminated object manufacturing method, the outline of the three-dimensional object is first realized by a computer, and then a layer of sheet material is precisely cut according to the outline. By stacking, bonding and cutting multiple layers of sheet material, the three-dimensional object is produced. Since the laser cutting step is required after each layer of sheet material is attached on the previous layer, the fabricating cost of the conventional laminated object manufacturing method is high and it takes a lot of time to repeatedly perform the laser cutting step. Moreover, since each layer of sheet material needs to be precisely cut by laser, the ambient temperature is very high. Under this circumstance, it is necessary to pay much attention to the operating safety of the laminated object manufacturing apparatus.

Moreover, the conventional three-dimensional printing method or the conventional laminated object manufacturing method is only capable of producing the three-dimensional object in the same apparatus. That is, the conventional rapid prototyping apparatus cannot be selectively operated in a two-dimensional printing mode or a three-dimensional printing mode. Under this circumstance, the applications thereof are restricted.

Therefore, there is a need of provides a rapid printing apparatus that is selectively operated in a two-dimensional printing mode or a three-dimensional printing mode and produces a three-dimensional object at a faster rate.

### SUMMARY OF THE INVENTION

An object of the present invention provides a rapid printing apparatus and a rapid printing method for producing a three-dimensional object at a faster rate.

Another object of the present invention provides a rapid printing apparatus and a rapid printing method. The rapid printing apparatus is selectively operated in a two-dimensional printing mode or a three-dimensional printing mode. Consequently, the applications are expanded.

In accordance with an aspect of the present invention, there is provided a rapid printing apparatus. The rapid printing apparatus is selectively operated in a two-dimensional printing mode or a three-dimensional printing mode. The rapid printing apparatus includes a sheet material supplying mechanism, a printing mechanism and a laminated sheet processing mechanism. The sheet material supplying mechanism is used for supplying a sheet material. The printing mechanism is used for printing on a specified area of the sheet material. In the two-dimensional printing mode, the laminated sheet processing mechanism cuts the printed sheet material to a specified size and collects the printed sheet material. In the three-dimensional printing mode, the laminated sheet processing mechanism cuts the printed sheet material to plural sheet segments with the specified size and laminates the plural sheet segments into a three-dimensional laminated block.

In accordance with another aspect of the present invention, there is provided a rapid printing apparatus. The rapid printing apparatus includes a sheet material supplying mechanism, a printing mechanism and a laminated sheet processing mechanism. The sheet material supplying mechanism is used for supplying a sheet material. The printing mechanism is used for printing on a specified area of the sheet material. The laminated sheet processing mechanism is for cutting the printed sheet material to plural sheet segments with a specified size and laminating the plural sheet segments into a three-dimensional laminated block.

In accordance with a further aspect of the present invention, there is provided a rapid printing method. Firstly, a sheet material supplying mechanism, a printing mechanism, a laminated sheet processing mechanism and a post-processing mechanism are provided. Then, the sheet material supplying mechanism supplies a sheet material. The printing mechanism prints on a specified area of the sheet material. The laminated sheet processing mechanism cuts the printed sheet material to plural sheet segments with a specified size and laminates the plural sheet segments into a three-dimensional laminated block. The post-processing mechanism thermally compacts the three-dimensional laminated block. The post-processing mechanism sinters, wet etches or rinses the three-dimensional laminated block, thereby producing a three-dimensional object.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a rapid printing apparatus according to a first embodiment of the present invention;

FIG. 1B is a schematic perspective view illustrating a portion of the rapid printing apparatus of FIG. 1A, in which a housing of the rapid printing apparatus is not shown;

FIG. 2A is a schematic perspective view illustrating an exemplary printing mechanism of the rapid printing apparatus of FIG. 1A;

FIG. 2B is a schematic perspective view illustrating another exemplary printing mechanism of the rapid printing apparatus of FIG. 1A;

FIG. 2C is a schematic perspective view illustrating another exemplary printing mechanism of the rapid printing apparatus of FIG. 1A;

FIG. 3A is a schematic perspective view illustrating a rapid printing apparatus according to a second embodiment of the present invention;

FIG. 3B is a schematic side view illustrating a portion of the rapid printing apparatus of FIG. 3A;

FIG. 4A is a flowchart illustrating a rapid printing method of the rapid printing apparatus in a two-dimensional printing mode; and

FIG. 4B is a flowchart illustrating a rapid printing method of the rapid printing apparatus in a three-dimensional printing mode.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

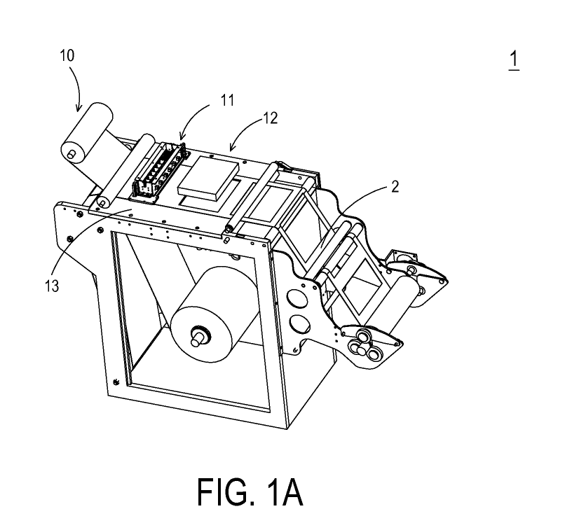

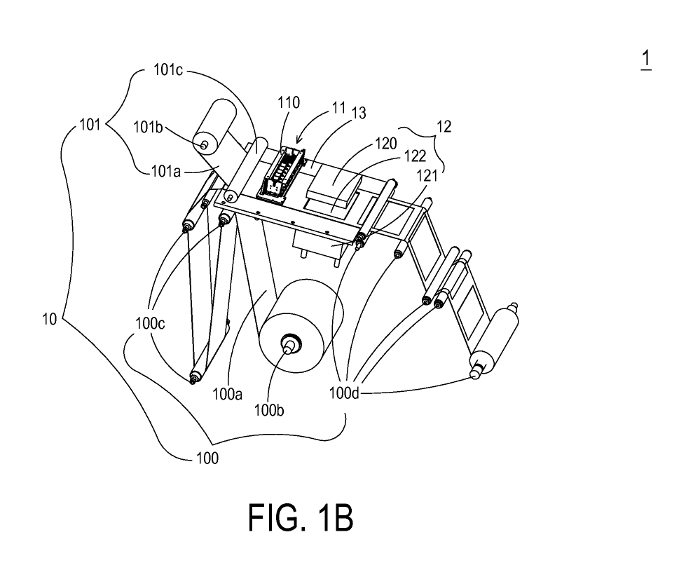

FIG. 1A is a schematic perspective view illustrating a rapid printing apparatus according to a first embodiment of the present invention. As shown in FIG. 1A, the rapid printing apparatus 1 at least comprises a sheet material supplying mechanism 10, a printing mechanism 11 and a laminated sheet processing mechanism 12. The printing mechanism 11 and the laminated sheet processing mechanism 12 are disposed over a working platform 13. The sheet material supplying mechanism 10 is used for supplying a sheet material 2. The printing mechanism 11 is used for printing on a specified area of the sheet material 2. After the sheet material 2 is printed by the printing mechanism 11, the printed sheet material 2 is cut to a specified size by the laminated sheet processing mechanism 12.

FIG. 1B is a schematic perspective view illustrating a portion of the rapid printing apparatus of FIG. 1A, in which a housing of the rapid printing apparatus is not shown. The sheet material supplying mechanism 10 is used for supplying the sheet material 2 in a batch manner or a continuous manner. In this embodiment as shown in FIG. 1B, the sheet material 2 is supplied by the sheet material supplying mechanism 10 in the continuous manner. The sheet material supplying mechanism 10 comprises a substrate supplying member 100 and a print medium supplying member 101. The substrate supplying member 100 is used for supplying a substrate 100a. The print medium supplying member 101 is used for supplying a print medium 101a. The substrate 100a and the print medium 101a can be combined as the sheet material 2.

In this embodiment, the substrate supplying member 100 comprises a first support roll 100b, plural guiding rolls 100c and a residual material recovering roll 100d. An example of the substrate 100a includes but is not limited to a paper. The substrate 100a is continuously wound around the first support roll 100b and guided by the plural guiding rolls 100c to be transferred to an inlet of the working platform 13. After the sheet material 2 is printed and cut, the residual material is recovered by the residual material recovering roll 100d. Consequently, the substrate 100a can be continuously supplied to the position over the working platform 13 and thermally pressed with the print medium 101a.

The print medium supplying member 101 comprises a second support roll 101b and a hot press roller 101c. An example of the print medium 101a includes but is not limited to a porous film such as a polymeric film, a plastic film, a ceramic film, a metallic film or a wooden film. The print medium 101a is continuously wound around the second support roll 101b. The print medium 101a is guided by the hot press roller 101c and thermally pressed with the substrate 100a. After the substrate 100a and the print medium 101a are compressed by the hot press roller 101c, the substrate 100a and the print medium 101a are combined together as the sheet material 2. After the sheet material 2 is printed and cut, the residual material is recovered by the residual material recovering roll 100d. Consequently, the substrate 100a can be continuously supplied to the position over the working platform 13 and subsequently printed and laminated.

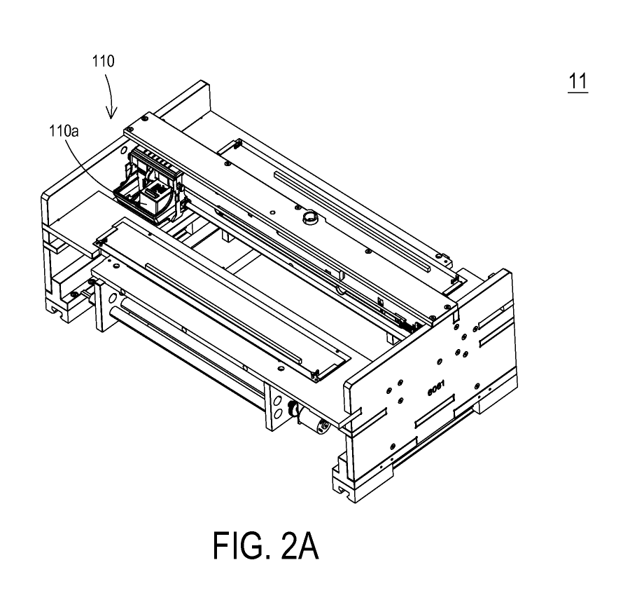

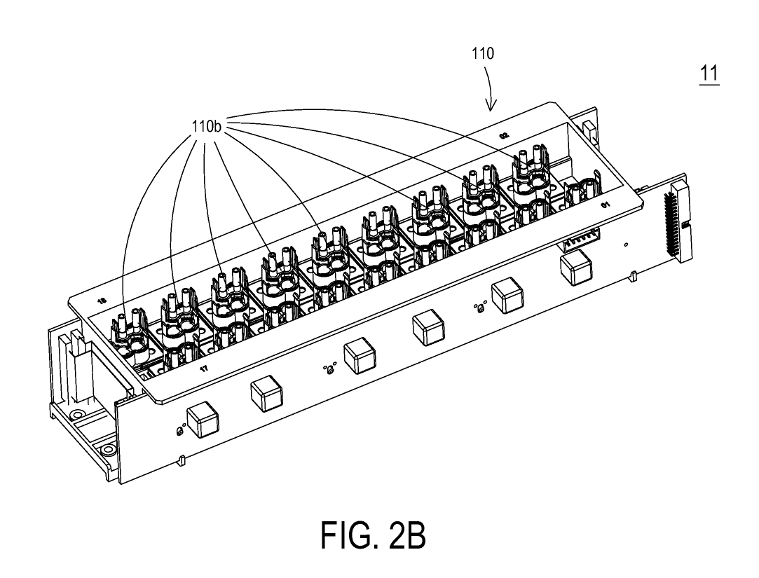

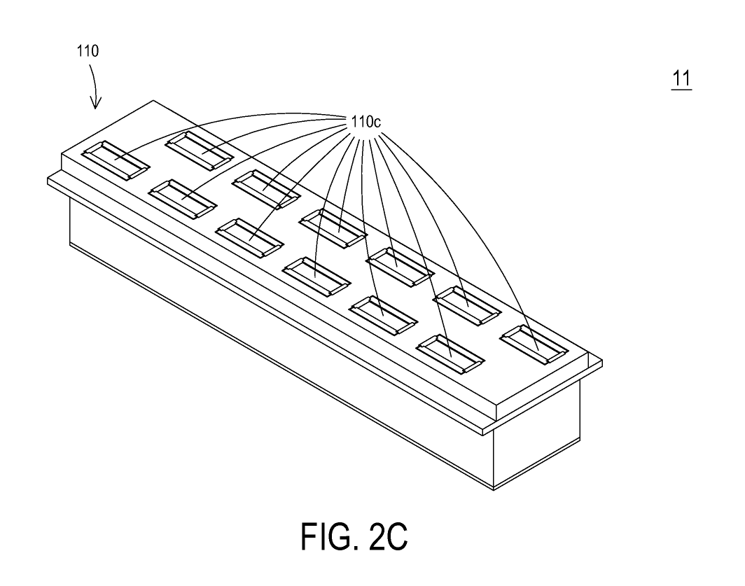

After the sheet material 2 is thermally pressed by the hot press roller 101c, the printing mechanism 11 prints on a specified area (not shown) of the sheet material 2. Hereinafter, some example of the printing mechanism 11 will be illustrated with reference to FIGS. 2A, 2B and 2C. As shown in FIG. 2A, the printing mechanism 11 comprises a printing platform 110 for supporting a single printhead 110a. Moreover, the printing platform 110 is movable in bidirectional reciprocation. As shown in FIG. 2B, the printing platform 110 of the printing mechanism 11 is a page-width printing platform with plural replaceable printheads 110b. As shown in FIG. 2C, the printing platform 110 of the printing mechanism 11 is a page-width printing platform with plural fixed printheads 110c. The page-width printing platform has increasing printing speed. It is noted that the types of the printing platforms 110 and the locations of the printheads 110a, 110b and 110c may be varied according to the practical requirements. Each of the printheads 110a, 110b and 110c can eject at least one of a monochromatic ink, a polychromatic ink, a colorless liquid binder and a colored liquid binder on the specified area of the sheet material 2 so as to form a geometric pattern or a text on the specified area of the sheet material 2. Consequently, an outline of the sheet material 2 is defined.

Please refer to FIG. 1B again. The laminated sheet processing mechanism 12 of the rapid printing apparatus 1 comprises a laminated sheet cutting member 120 and a laminated sheet collector 121. After the sheet material 2 is printed by the printing mechanism 11, the printed sheet material 2 is cut to a specified size by the laminated sheet cutting member 120 and collected by the laminated sheet collector 121. In this embodiment, after the sheet material 2 is continuously supplied by the sheet material supplying mechanism 10 and printed by the printing mechanism 11, the sheet material 2 is sequentially cut to plural sheet segments by the laminated sheet cutting member 120. The size of each sheet segment is larger than the printed outline. Moreover, it is not necessary to precisely cut the sheet material 2. While the sheet material 2 is sequentially cut to the plural sheet segments by the laminated sheet cutting member 120, the plural sheet segments are sequentially sent to the laminated sheet collector 121 and sequentially laminated into a three-dimensional laminated block by the laminated sheet cutting member 120. Moreover, after the sheet material 2 is printed and cut, the residual material is recovered by the residual material recovering roll 100d.

The rapid printing apparatus 1 further comprises a post-processing mechanism (not shown). The post-processing mechanism is used for removing undesired portion of the three-dimensional laminated block. In an embodiment, the post-processing mechanism comprises a thermal compact device (not shown) and an excess material removing device (not shown). After the three-dimensional laminated block in the laminated sheet collector 121 is produced, the three-dimensional laminated block is thermally compacted by the thermal compact device. Consequently, the three-dimensional laminated block becomes denser. The operating temperature, operating time and other operating parameters can be determined according to the properties of the sheet material 2.

In an embodiment, the excess material removing device is a sintering device. After the three-dimensional laminated block is thermally compacted by the thermal compact device, the three-dimensional laminated block is initially sintered by the sintering device. The sintering temperature is in the range between 200 and 300° C. The sintering device is used for sintering the in order to carbonize or embrittle the unprinted area of the sheet material. In case that the substrate 100a is a paper, the substrate 100a is carbonized by the sintering device. In case that the print medium 101a is a plastic film, a ceramic film, a metallic film or a wooden film, the print medium 101a is embrittled by the sintering device. After the three-dimensional laminated block is initially sintered by the sintering device, the three-dimensional laminated block is removed from the sintering device. Consequently, the undesired portion of the three-dimensional laminated block corresponding to the unprinted area can be easily stripped off. Meanwhile, a green part of the three-dimensional object is obtained.

In another embodiment, the excess material removing device is a wet etching device. After the three-dimensional laminated block is thermally compacted by the thermal compact device, the three-dimensional laminated block is wet etched or rinsed by the wet etching device. In case that the print medium 101a is a polymeric film, the undesired portion of the three-dimensional laminated block corresponding to the unprinted area can be easily stripped off by the wet etching device. Meanwhile, a green part of the three-dimensional object is obtained.

Generally, the green part of the three-dimensional object has large pores in the surface and inside thereof. Meanwhile, the structural strength is weak. After the green part of the three-dimensional object is obtained, a post-processing agent is filled and infiltrated into the green part of the three-dimensional object, and then the green part of the three-dimensional object is re-sintered by the sintering device again. After the green part of the three-dimensional object is re-sintered, the three-dimensional object with increased structural strength is produced.

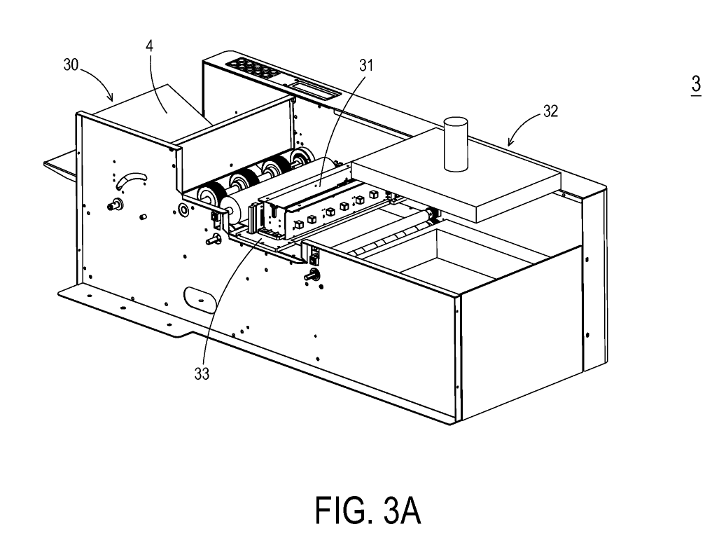

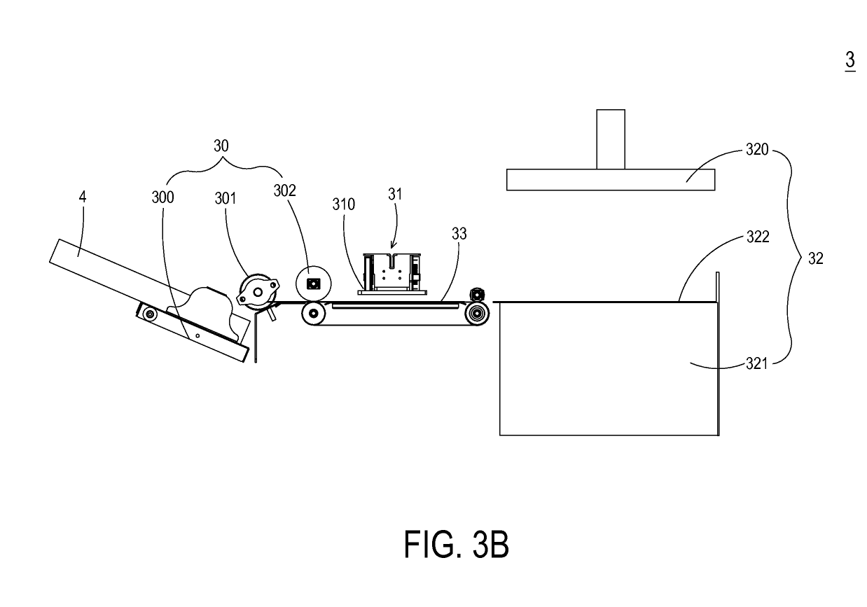

FIG. 3A is a schematic perspective view illustrating a rapid printing apparatus according to a second embodiment of the present invention. FIG. 3B is a schematic side view illustrating a portion of the rapid printing apparatus of FIG. 3A. As shown in FIG. 3A, the rapid printing apparatus 3 at least comprises a sheet material supplying mechanism 30, a printing mechanism 31 and a laminated sheet processing mechanism 32. The printing mechanism 31 and the laminated sheet processing mechanism 32 are disposed over a working platform 33. The sheet material supplying mechanism 30 is used for supplying a sheet material 4. The printing mechanism 31 is used for printing on a specified area of the sheet material 4. After the sheet material 4 is printed by the printing mechanism 31, the printed sheet material 4 is cut to a specified size by the laminated sheet processing mechanism 32. In comparison with the first embodiment, the sheet material supplying mechanism 30 is used for supplying the sheet material 4 in a batch manner.

As shown in FIG. 3B, the sheet material supplying mechanism 30 comprises a support tray 300, a feeding roller 301 and a hot press roller 302. The support tray 300 is used for supporting the sheet material 4. In this embodiment, the sheet material 4 is a combination of a paper and one of a polymeric film, a plastic film, a ceramic film, a metallic film and a wooden film. After the sheet material 4 is cut to plural single sheet segments with a desired print size, the plural single sheet segments are placed on the support tray 300. Then, the single sheet segment is guided by the feeding roller 301 and thermally pressed by the hot press roller 302. After the printing mechanism 31 prints on a specified area (not shown) of the single sheet segment, the single sheet segment is cut to a specified size by the laminated sheet processing mechanism 32. In this embodiment, the printing mechanism 31 comprises a printing platform 310. The printing platform 310 is located over the working platform 33. Moreover, the printing platform 310 is movable or fixed. The examples of the printing platform 310 are diverse. For example, as shown in FIG. 2A, the printing platform 310 is movable in bidirectional reciprocation and comprises a single printhead. As shown in FIG. 2B, the printing platform is a page-width printing platform with plural replaceable printheads. As shown in FIG. 2C, the printing platform is a page-width printing platform with plural fixed printheads. In this embodiment, the printing platform is a page-width printing platform with plural fixed printheads. The page-width printing platform has increasing printing speed. Each of the printheads can eject at least one of a monochromatic ink, a polychromatic ink, a colorless liquid binder and a colored liquid binder on the specified area of the single sheet segment so as to form a geometric pattern or a text.

In an embodiment, the printing mechanism 31 can print on a single sheet segment of the sheet material 4. In particular, after the sheet material supplying mechanism 30 transfers the single sheet segment of the sheet material 4 to the working platform 33, the printing mechanism 31 print a geometric pattern or a text on the specified area of the single sheet segment. The laminated sheet processing mechanism 32 comprises a laminated sheet cutting member 320 and a laminated sheet collector 321. Then, the printed sheet material 4 is collected in the laminated sheet collector 321. Meanwhile, a two-dimensional printing operation of the single sheet segment of the sheet material 4 is completed. Optionally, after the two-dimensional printing operation of the single sheet segment is completed, the printed sheet segment is cut to a specified size by the laminated sheet cutting member 320.

In another embodiment, the sheet material supplying mechanism 30 supplies the sheet material 4 in a continuous manner. The sheet material supplying mechanism 30 sequentially transfers plural sheet segments of the sheet material 4 to the working platform 33, and the printing mechanism 31 sequentially print a geometric pattern or a text on the specified area of each sheet segment. Meanwhile, a two-dimensional printing operation of the sheet segment of the sheet material 4 is completed. Optionally, each sheet segment is cut to a specified size by the laminated sheet processing mechanism 32.

Moreover, the rapid printing apparatus 3 can be used for producing a three-dimensional object. As shown in FIG. 3B, plural sheet segments of the sheet material 4 are placed on the support tray 300. Then, one of the plural sheet segments is guided by the feeding roller 301 and thermally pressed by the hot press roller 302. After the sheet material supplying mechanism 30 transfers the sheet segment to the working platform 33, the printing mechanism 31 print a geometric pattern or a text on the specified area of the sheet segment. Then, the printed sheet material 4 is collected in the laminated sheet collector 321.

Then, the above procedures are repeatedly performed to print on the other sheet segments. The printed sheet segments are cut to a specified size by the laminated sheet cutting member 320, and the sheet segments are collected by the laminated sheet collector 321. Moreover, a lift/lower mechanism 322 is disposed within the laminated sheet collector 321. After the sheet segments are collected in the laminated sheet collector 321, the sheet segments are supported by the lift/lower mechanism 322. Moreover, whenever the sheet segment is cut, the lift/lower mechanism 322 is lowered by a specified distance, which is substantially equal to thickness of the sheet material 4. Consequently, the sheet segments can be collected in the laminated sheet collector 321. In this embodiment, after the sheet segments are sequentially supplied by the sheet material supplying mechanism 30 and printed by the printing mechanism 31, the sheet segments are sequentially cut to the specified size by the laminated sheet cutting member 320. The size of each sheet segment is larger than the printed outline. Consequently, it is not necessary to precisely cut the sheet material 4. While the sheet segments are collected by the laminated sheet collector 321, the sheet segments are sequentially laminated into a three-dimensional laminated block by the laminated sheet cutting member 320. Under this circumstance, a three-dimensional printing operation is completed.

Similarly, the rapid printing apparatus 3 further comprises a post-processing mechanism (not shown). The post-processing mechanism is used for removing undesired portion of the three-dimensional laminated block. In an embodiment, the post-processing mechanism comprises a thermal compact device (not shown) and an excess material removing device (not shown). After the three-dimensional laminated block in the laminated sheet collector 321 is produced, the three-dimensional laminated block is thermally compacted by the thermal compact device. Consequently, the three-dimensional laminated block becomes denser. In an embodiment, the excess material removing device is a sintering device. After the three-dimensional laminated block is thermally compacted by the thermal compact device, the three-dimensional laminated block is initially sintered by the sintering device. The sintering device is used for sintering the in order to carbonize or embrittle the unprinted area of the sheet material. Consequently, a green part of the three-dimensional object is obtained. In another embodiment, the excess material removing device is a wet etching device. After the three-dimensional laminated block is wet etched or rinsed by the wet etching device, the undesired portion of the three-dimensional laminated block corresponding to the unprinted area can be easily stripped off by the wet etching device. Consequently, a green part of the three-dimensional object is obtained.

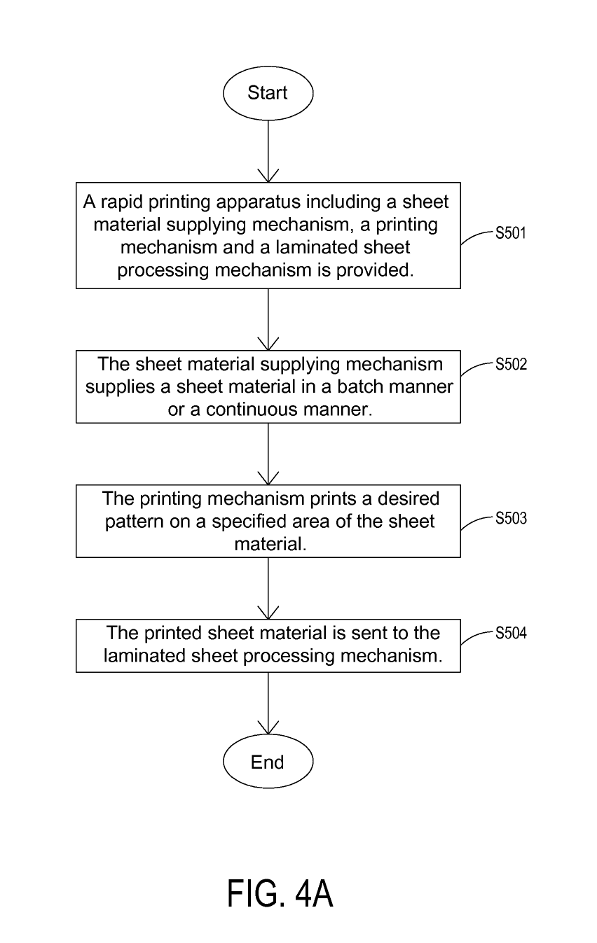

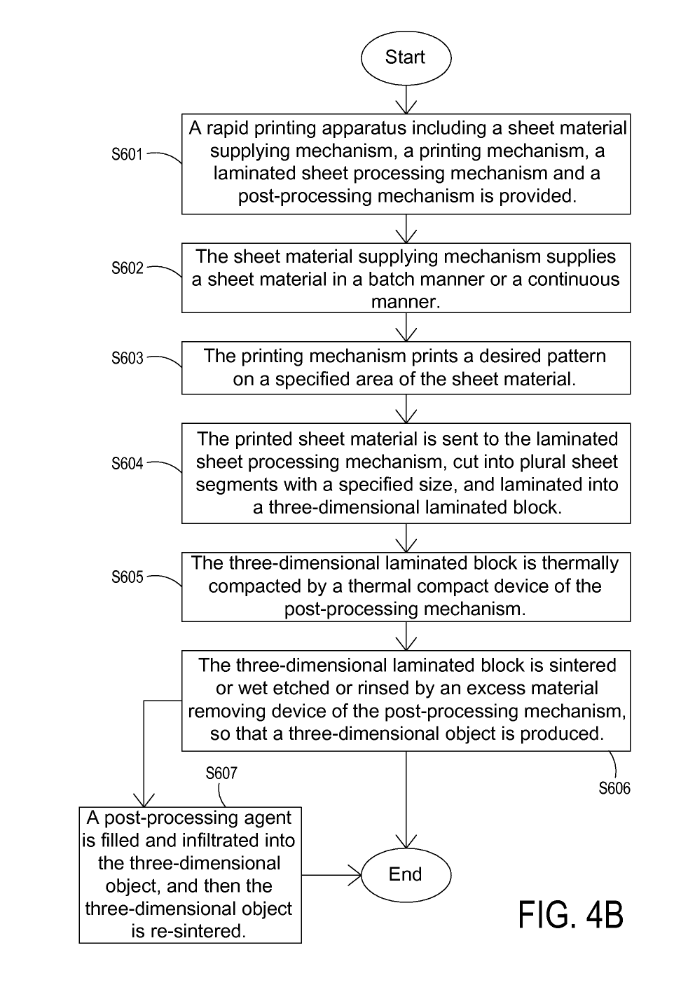

From the above descriptions, the sheet material can be supplied by the sheet material supplying mechanism in a batch manner or a continuous manner. Moreover, the rapid printing apparatus can be selectively operated in a two-dimensional printing mode or a three-dimensional printing mode. Hereinafter, the operations of the rapid printing apparatus will be illustrated with reference to FIGS. 4A and 4B.

FIG. 4A is a flowchart illustrating a rapid printing method of the rapid printing apparatus in a two-dimensional printing mode. Firstly, in the step S501, a rapid printing apparatus is provided. The rapid printing apparatus at least comprises a sheet material supplying mechanism, a printing mechanism and a laminated sheet processing mechanism. Then, in the step S502, the sheet material supplying mechanism supplies a sheet material in a batch manner or a continuous manner. Then, in the step S503, the sheet material is transferred to the working platform and the printing mechanism prints a desired pattern on a specified area of the sheet material. Then, in the step S504, the printed sheet material is collected by the laminated sheet collector of the laminated sheet processing mechanism. In case that the sheet material is supplied in the batch manner, the sheet material can be previously cut to plural single sheet segments with a desired print size. The printed sheet segment is directly sent to the laminated sheet collector of the laminated sheet processing mechanism. Whereas, in case that the sheet material is supplied in the continuous manner, the printed sheet segments are sequentially cut to a specified size by the laminated sheet cutting member, and the sheet segments are sequentially collected by the laminated sheet collector.

FIG. 4B is a flowchart illustrating a rapid printing method of the rapid printing apparatus in a three-dimensional printing mode. Firstly, in the step S601, a rapid printing apparatus is provided. The rapid printing apparatus at least comprises a sheet material supplying mechanism, a printing mechanism, a laminated sheet processing mechanism and a post-processing mechanism. Then, in the step S602, the sheet material supplying mechanism supplies a sheet material in a batch manner or a continuous manner. Then, in the step S603, the sheet material is transferred to the working platform and the printing mechanism prints a desired pattern on a specified area of the sheet material. Meanwhile, a single sheet segment of the sheet material is printed. Then, in the step S604, the printed sheet material is collected by the laminated sheet collector of the laminated sheet processing mechanism, and cut to a specified size by the laminated sheet cutting member of the laminated sheet processing mechanism. While the sheet material is sequentially cut to the plural sheet segments by the laminated sheet cutting member, the plural sheet segments are sequentially sent to the laminated sheet collector and sequentially laminated into a three-dimensional laminated block by the laminated sheet cutting member. Then, in the step S605, the three-dimensional laminated block is thermally compacted by a thermal compact device of the post-processing mechanism. Consequently, the three-dimensional laminated block becomes denser. Then, in the step S606, the three-dimensional laminated block is sintered by a sintering device or wet etched or rinsed by a wet etching device. The sintering device is used for sintering the in order to carbonize or embrittle the unprinted area of the sheet material. The undesired portion of the three-dimensional laminated block corresponding to the unprinted area can be easily stripped off by the wet etching device. Consequently, a green part of a three-dimensional object is obtained. Optionally, for increasing the structural strength of the three-dimensional object, a step S607 is performed. In the step S607, a post-processing agent is filled and infiltrated into the pores of the green part of the three-dimensional object, and then the green part of the three-dimensional object is re-sintered by the sintering device again. After the green part of the three-dimensional object is re-sintered, the three-dimensional object with increased structural strength is produced.

From the above descriptions, the present invention provides a rapid printing apparatus is provided. The rapid printing apparatus comprises a sheet material supplying mechanism, a printing mechanism, a laminated sheet processing mechanism and a post-processing mechanism. The sheet material supplying mechanism supplies a sheet material in a batch manner or a continuous manner. The printing mechanism comprises a printing platform that is movable in bidirectional reciprocation and has a single printhead, or the printing mechanism comprises a page-width printing platform with plural replaceable printheads or plural fixed printheads. After the sheet material is printed by the printing mechanism, the printed sheet material is sent to the laminated sheet processing mechanism. While the sheet material is sequentially cut to the plural sheet segments by the laminated sheet cutting member, the plural sheet segments are sequentially sent to the laminated sheet collector and sequentially laminated into a three-dimensional laminated block by the laminated sheet cutting member. Then, the three-dimensional laminated block is sintered by a sintering device or wet etched or rinsed by a wet etching device. Consequently, a three-dimensional object is produced. Moreover, if the subsequent laminating process and post-processing process are not omitted, the two-dimensional printing operation is performed. In other words, the rapid printing apparatus of the present invention can be selectively operated in a two-dimensional printing mode or a three-dimensional printing mode. In case that the rapid printing apparatus of the present invention is operated in the three-dimensional printing mode, the printing speed is larger than 40 PPM. Moreover, since the size of each sheet segment is larger than the printed outline, it is not necessary to precisely cut the sheet material. In other words, the time period of producing the three-dimensional object by the rapid printing apparatus of the present invention is largely reduced (e.g., about 1 hour). When compared with the conventional rapid prototyping apparatus, the rapid printing apparatus of the present invention can produce the three-dimensional object in a fast and cost-effective manner. Moreover, since the rapid printing apparatus of the present invention can be selectively operated in a two-dimensional printing mode or a three-dimensional printing mode, the applications are expanded.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rapid printing apparatus selectively operated in a two-dimensional printing mode or a three-dimensional printing mode, the rapid printing apparatus comprising:
a sheet material supplying mechanism for supplying a sheet material;
a printing mechanism for printing on a specified area of the sheet material; and
a laminated sheet processing mechanism, wherein in the two-dimensional printing mode, the laminated sheet processing mechanism cuts the printed sheet material to a specified size and collects the printed sheet material, wherein in the three-dimensional printing mode, the laminated sheet processing mechanism cuts the printed sheet material to plural sheet segments with the specified size and laminates the plural sheet segments into a three-dimensional laminated block.

2. The rapid printing apparatus according to claim 1, wherein the sheet material is supplied by the sheet material supplying mechanism in a batch manner or a continuous manner.

3. The rapid printing apparatus according to claim 1, wherein the sheet material supplying mechanism comprises
a substrate supplying member for supplying a substrate; and
a print medium supplying member for supplying a print medium, wherein the substrate and the print medium are combined as the sheet material.

4. The rapid printing apparatus according to claim 1, wherein the substrate is a paper, and the print medium is a polymeric film, a plastic film, a ceramic film, a metallic film or a wooden film.

5. The rapid printing apparatus according to claim 1, wherein the printing mechanism comprises a printing platform with a printhead, wherein the printing platform is movable in bidirectional reciprocation.

6. The rapid printing apparatus according to claim 1, wherein the printing mechanism comprises a page-width printing platform with plural replaceable printheads.

7. The rapid printing apparatus according to claim 1, wherein the printing mechanism comprises a page-width printing platform with plural fixed printheads.

8. The rapid printing apparatus according to claim 1, wherein the printing mechanism comprises at least one printhead, wherein the printhead ejects a monochromatic ink, a polychromatic ink, a colorless liquid binder or a colored liquid binder on the specified area of the sheet material so as to form a geometric pattern or a text on the specified area of the sheet material.

9. The rapid printing apparatus according to claim 1, wherein the laminated sheet processing mechanism comprises a laminated sheet cutting member and a laminated sheet collector, wherein the printed sheet material is sequentially cut to the plural sheet segments with the specified size, and the plural sheet segments are sequentially collected by the laminated sheet collector and laminated into the three-dimensional laminated block by the laminated sheet cutting member.

10. The rapid printing apparatus according to claim 1, further comprising a post-processing mechanism for removing undesired portion of the three-dimensional laminated block, so that a three-dimensional object is produced.

11. The rapid printing apparatus according to claim 10, wherein the post-processing mechanism comprises a thermal compact device for thermally compacting the three-dimensional laminated block.

12. The rapid printing apparatus according to claim 11, wherein the post-processing mechanism further comprises an excess material removing device, wherein the excess material removing device is a sintering device for sintering the three-dimensional laminated block in order to carbonize or embrittle unprinted area of the sheet material, or the excess material removing device is a wet etching device for wet etching or rinsing the three-dimensional laminated block in order to remove the unprinted area of the sheet material.

13. A rapid printing apparatus, comprising:
a sheet material supplying mechanism for supplying a sheet material;
a printing mechanism for printing on a specified area of the sheet material; and
a laminated sheet processing mechanism for cutting the printed sheet material to plural sheet segments with a specified size and laminating the plural sheet segments into a three-dimensional laminated block.

14. The rapid printing apparatus according to claim 13, wherein the laminated sheet processing mechanism comprises a laminated sheet cutting member and a laminated sheet collector, wherein the printed sheet material is sequentially cut to the plural sheet segments with the specified size, and the plural sheet segments are sequentially collected by the laminated sheet collector and laminated into the three-dimensional laminated block by the laminated sheet cutting member.

15. The rapid printing apparatus according to claim 13, further comprising a post-processing mechanism for removing undesired portion of the three-dimensional laminated block, so that a three-dimensional object is produced.

16. The rapid printing apparatus according to claim 15, wherein the post-processing mechanism comprises a thermal compact device for thermally compacting the three-dimensional laminated block.

17. The rapid printing apparatus according to claim 16, wherein the post-processing mechanism further comprises an excess material removing device, wherein the excess material removing device is a sintering device for sintering the three-dimensional laminated block in order to carbonize or embrittle unprinted area of the sheet material, or the excess material removing device is a wet etching device for wet etching or rinsing the three-dimensional laminated block in order to remove the unprinted area of the sheet material.

18. A rapid printing method, comprising steps of:
(a) providing a sheet material supplying mechanism, a printing mechanism, a laminated sheet processing mechanism and a post-processing mechanism;
(b) allowing the sheet material supplying mechanism to supply a sheet material;
(c) allowing the printing mechanism to print on a specified area of the sheet material;
(d) allowing the laminated sheet processing mechanism to cut the printed sheet material to plural sheet segments with a specified size and laminate the plural sheet segments into a three-dimensional laminated block;
(e) allowing the post-processing mechanism to thermally compact the three-dimensional laminated block; and
(f) allowing the post-processing mechanism to sinter, wet etch or rinse the three-dimensional laminated block, thereby producing a three-dimensional object.

19. The rapid printing method according to claim 18, wherein the sheet material is supplied by the sheet material supplying mechanism in a batch manner or a continuous manner.

20. The rapid printing method according to claim 18, wherein after the step (f), the rapid printing method further comprises a step (g) of filling and infiltrating a post-processing agent into the three-dimensional object and re-sintering the three-dimensional object, thereby increasing structural strength of the three-dimensional object.
